(19) United States
(12) Patent Application Publication
(10) Pub. No.: US 2023/0299266 A1
(43) Pub. Date: Sep. 21, 2023

(54) Bipolar Storage Battery

(71) Applicants: Furukawa Electric Co., Ltd., Tokyo (JP); The Furukawa Battery Co., Ltd., Yokohama (JP)

(72) Inventors: Yasuo Nakajima, Tokyo (JP); Hiroki Tanaka, Tokyo (JP); Kenichi Suyama, Tokyo (JP); Akira Tanaka, Tokyo (JP)

(21) Appl. No.: 18/323,089

(22) Filed: May 24, 2023

Related U.S. Application Data
(63) Continuation of application No. PCT/JP2021/040417, filed on Nov. 2, 2021.

(30) Foreign Application Priority Data
Nov. 25, 2020 (JP) 2020-195488
Nov. 25, 2020 (JP) 2020-195489

(51) Int. Cl. H01M 4/14; H01M 10/18; H01M 50/102

(52) U.S. Cl. CPC H01M 4/14; H01M 10/18; H01M 50/102; H01M 2004/029

(57) ABSTRACT

A bipolar lead storage battery includes a plurality of cell members laminated on one another, inner frames that each include a bipolar plate provided between the cell members, and a frame member (a rim) provided in an outer peripheral portion of the bipolar plate to rise in a thickness direction of the bipolar plate. The bipolar lead storage battery also includes a pair of outer frames respectively placed at opposite end portions in a lamination direction. The inner frames or the outer frames are made of fiber reinforced thermoplastic resin. The arrangement restrains deformation of an inner frame or an outer frame due to the pressure inside a cell and allows a reduced thickness of the inner frame or the outer frame.

### CROSS-REFERENCE TO RELATED APPLICATION(S)

This application is a continuation of PCT Application No. PCT/JP2021/040417, filed Nov. 2, 2021, the disclosure of which is incorporated herein in its entirety by reference.

### TECHNICAL FIELD

The present invention relates to a bipolar storage battery.

### BACKGROUND

A bipolar lead storage battery is configured such that a plurality of cell members is laminated via a substrate (a bipolar plate) made of resin (see JP Patent Publication No. 6124894 B). The cell members each include a positive electrode in which a positive active material layer is provided on a positive lead layer, a negative electrode in which a negative active material layer is provided on a negative lead layer, and an electrolytic layer provided between the positive electrode and the negative electrode. The positive lead layer of one of the cell members disposed with one substrate being sandwiched therebetween is joined to the negative lead layer of another one of the cell members via a through-hole formed in the substrate, so that the cell members are connected in series to each other.

Further, in the bipolar lead storage battery described in JP Patent Publication No. 6124894 B, a frame member (a rim) made of resin and forming a frame shape is provided on the outer periphery of the substrate (the bipolar plate) made of resin to constitute an inner frame. A chamber formed between inner frames adjacent to each other and a chamber formed between an outer frame as a frame at an end portion and the inner frame constitute cells in which respective cell members are stored.

The inner frame or the outer frame constituting a framework (a frame) of the battery is made of ABS resin, for example.

### SUMMARY

The electrolytic layer is constituted by a glass-fiber mat impregnated with an electrolytic solution containing sulfuric acid, for example. The glass-fiber mat has elasticity, and from the viewpoint of securing a sufficient adhesion property between the positive active material layer and the negative active material layer, the glass-fiber mat is stored in each cell in a compressed state.

Because of this, a load in a direction where the substrates are separated from each other is always applied between the inner frames forming the cells due to repulsion by the compression of the glass-fiber mats. As a result, a load is always applied to a joined portion between the inner frames, and therefore, the joined portion is requested to have a sufficient strength. Further, a strength sufficient to restrain deformation of the substrate is also required. Because of this, a problem with the conventional technology is that the thickness of the substrate cannot be thinned.

Further, at the time the bipolar lead storage battery is used, a pressure is also caused by oxygen gas generated by decomposition of water in the electrolytic layer. Therefore, the repulsion to the inner frames further increases. Accordingly, from the viewpoint of securing long-term reliability, the thickness of the substrate cannot be thinned.

Such a problem also occurs between the outer frame and the inner frame forming a cell. From the viewpoint of prevention of deformation of the outer frame or securing a predetermined strength in the joined portion between the outer frame and the inner frame, the conventional technology also has a problem that the thickness of the outer frame cannot be thinned.

Particularly, the outer frame is a frame placed at an end portion in a lamination direction (a thickness direction), and therefore, the outer frame more easily deforms than the inner frame. Because of this, it is necessary to thicken an end plate of the outer frame. However, there is a problem that, as the end plate becomes thicker, a sink mark or strain is easily caused at the time of manufacture by injection molding.

Here, as the thickness of the inner frame or the outer frame is thicker, the bipolar lead storage battery is upsized, and its weight increases proportionally.

The present invention is accomplished in view of the above problems, and an object of the present invention is to restrain deformation of an inner frame or an outer frame due to pressure inside a cell and to reduce the thickness of the inner frame or the outer frame.

To solve the problems, a bipolar electrode according to one aspect of the present invention is a bipolar storage battery including a plurality of cell members laminated on one another, the plurality of cell members each including a positive electrode and a negative electrode placed to face each other via an electrolytic layer. The bipolar electrode includes inner frames, each including a bipolar plate provided between adjacent cell members, a rim integrally connected to a whole outer peripheral portion of the bipolar plate and rising in a thickness direction of the bipolar plate, and a pair of outer frames respectively placed at opposite end portions in a lamination direction of the plurality of cell members thus laminated on one another. The inner frames, the outer frames, or both are made of fiber reinforced thermoplastic resin.

In embodiments of the present invention, by using the fiber reinforced thermoplastic resin for the inner frames, for example, the mechanical strength of the inner frames is raised. As a result, with embodiments of the present invention, it is possible to restrain the inner frames from deforming due to the pressure inside cells and to thin the inner frames. This accordingly makes it possible to prevent upsizing of the bipolar storage battery and to reduce the weight.

The outer frames may be made of fiber reinforced thermoplastic resin. In this configuration, because the fiber reinforced thermoplastic resin is used for the outer frames, the mechanical strength of the outer frames is also raised. As a result, it is possible to restrain the outer frames from deforming due to the pressure inside the cells and to thin the outer frame. Further, the moldability of the outer frames improves by thinning the outer frames. As a result, it is possible to further prevent upsizing of the bipolar storage battery or to reduce the weight.

Further, even in a case where each of the outer frames has a structure including an end plate having a plate shape, and a rise portion integrally connected to an outer peripheral portion of the end plate and rising toward the rim, when the outer frames are thinned, it is possible to provide outer frames molded with accuracy such that a sink mark or distortion at the time of injection molding is restrained.

The fiber reinforced thermoplastic resin may be fiberglass-reinforced ABS resin. With this configuration, it is possible to improve the mechanical strength of at least one of the inner frames or the outer frames. As a result, it is possible to reduce the thickness and the weight of at least the inner frames.

The fiberglass-reinforced ABS resin may have a composition that the content of glass fiber is equal to or more than 10% by mass but equal to or less than 30% by mass. With this configuration, it is possible to improve the mechanical strength of at least the inner frames out of the inner frames and the outer frames.

The positive electrode and the negative electrode each include a lead layer and an active material layer disposed on the lead layer, and the lead layer may be fixed to the bipolar plate with an adhesive. With this configuration, the lead layer is fixed to the bipolar plate or the like. As a result, the corrosion resistance of the lead layer improves. Particularly, the deformation of the inner frames is restrained at the time of manufacture and at the time of use. Thereby, the movement of the lead layer is restrained more, so that the corrosion resistance of the lead layer improves.

The positive electrode and the negative electrode each include a lead layer and an active material layer disposed on the lead layer, and the lead layer may be fixed to the end plate with an adhesive. In this configuration, because the lead layer is fixed to the end plate, the corrosion resistance of the lead layer improves. Particularly, the deformation of the outer frames is restrained at the time of manufacture and at the time of use. Thereby, the movement of the lead layer is restrained more, so that the corrosion resistance of the lead layer improves.

### BRIEF DESCRIPTION OF THE DRAWINGS

FIG. 1 is a sectional view to describe a structure of a bipolar lead storage battery according to an embodiment of the present invention.

### DETAILED DESCRIPTION

Here, the same constituent is described with the same reference sign being attached thereto. Further, in each drawing, the thickness or the proportion of each constituent may be exaggerated, and the number of constituents may be also illustrated to differ from an implemented product. Further, the present invention is not limited to what is described in the following embodiments, the present invention can be embodied by appropriate combinations or modifications without departing from the object of the present invention, and embodiments with such changes or improvements can be also included in scope of the present invention.

### Configuration

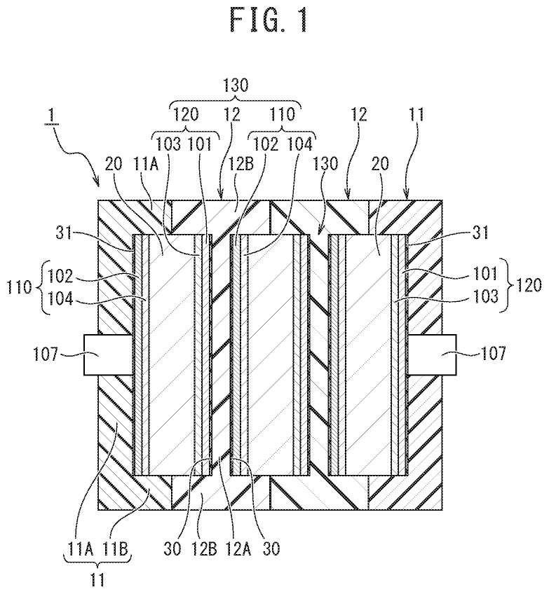

The following description deals with a bipolar lead storage battery as an example of a bipolar storage battery, but this disclosure is also applicable to a bipolar storage battery other than a bipolar lead storage battery. A structure of a bipolar lead storage battery 1 according to an embodiment will be described with reference to FIG. 1.

The bipolar lead storage battery 1 illustrated in FIG. 1 is constituted by a plurality of bipolar electrodes 130 laminated in a thickness direction via an electrolytic layer 20. Respective electrolytic layers 20 are laminated separately on both end portions, in a lamination direction, of a bipolar electrode group thus formed by lamination. An electrolytic layer 20 placed at a left end in FIG. 1 is electrically connected to a terminal 107 (i.e., a negative terminal) via a negative electrode 110, and an electrolytic layer 20 placed at a right end in FIG. 1 is electrically connected to a terminal 107 (i.e., a positive terminal) via a positive electrode 120. The negative electrode 110 or the positive electrode 120 on a lamination-direction end portion side is attached to a main body portion 11A (an end plate) of an outer frame 11 via an adhesive layer 31. The outer frame 11 includes a main body portion 11A having a flat plate shape and a rise portion 11B (a rim) rising from a whole outer peripheral portion of the main body portion 11A.

The bipolar electrodes 130 illustrated in FIG. 1 each include an inner frame 12, the positive electrode 120, and the negative electrode 110. As illustrated in FIG. 1, the inner frame 12 of the present embodiment is constituted by a bipolar plate 12A (a substrate) having a flat plate shape and a frame member 12B (a rim) integrally connected to a whole outer peripheral portion of the bipolar plate 12A. The frame member 12B rises in a thickness direction of the bipolar plate 12A. FIG. 1 illustrates a case where the frame member 12B rises toward the opposite sides in the thickness direction of the bipolar plate 12A.

The positive electrode 120 is attached to one surface of the bipolar plate 12A via an adhesive layer 30. The positive electrode 120 includes a positive lead layer 101 and a positive active material layer 103 disposed on the positive lead layer 101. The positive lead layer 101 is made of lead or lead alloy and has a foil shape (lead foil), for example. The positive lead layer 101 is fixed to the one surface of the bipolar plate 12A with an adhesive.

Further, the negative electrode 110 is attached to the other surface of the bipolar plate 12A via an adhesive layer 30. The negative electrode 110 includes a negative lead layer 102 and a negative active material layer 104 disposed on the negative lead layer 102. The negative lead layer 102 is made of lead or lead alloy and has a foil shape (lead foil), for example. The negative lead layer 102 is fixed to the other surface of the bipolar plate 12A with an adhesive.

Here, the bipolar plate 12A has a conductive portion (not illustrated) constituted by a through-hole or the like via which the positive lead layer 101 is conductive to the negative lead layer 102, and the positive lead layer 101 is electrically joined to the negative lead layer 102 via the conductive portion.

Here, one cell member is constituted by the electrolytic layer 20 and by the positive electrode 120 and the negative electrode 110 facing each other across the electrolytic layer 20. Further, the bipolar lead storage battery 1 is configured such that a plurality of cell members is laminated via the bipolar plates 12A, and the plurality of cell members is electrically connected in series to each other via the conductive portions provided in the bipolar plates 12A. In FIG. 1, a bipolar lead storage battery including three cell members is illustrated. The number of cell members is set in accordance with a power storage capacity required by the bipolar lead storage battery.

Further, a space between the inner frames 12 adjacent to each other, formed by joining the frame members 12B rising from respective outer peripheries of the bipolar plates 12A of the inner frames 12 adjacent to each other, constitutes a chamber (a cell) in which a cell member is stored. The same can be applied to between the outer frame 11 and the inner frame 12, and a space between the outer frame 11 and the inner frame 12 constitutes a chamber (a cell) in which a cell member is stored, the space being formed by joining the frame member 12B rising from the whole outer periphery of the bipolar plate 12A of the inner frame 12 to the rise portion 11B rising toward the frame member 12B from the outer periphery of the main body portion 11A of the outer frame 11.

The inner frames 12 and the outer frames 11 constitute a framework (a frame) of the battery.

### Materials for Inner Frame and Outer Frame

In the present embodiment, at least the inner frame 12 out of the inner frame 12 and the outer frame 11 is made of fiber reinforced thermoplastic resin.

Thermoplastic resin constituting the fiber reinforced thermoplastic resin is, for example, an acrylonitrile-butadiene-styrene copolymer (ABS) resin or polypropylene. These thermoplastic resins are excellent in moldability and in sulfuric-acid resistance. Accordingly, even when the electrolytic solution contacts the bipolar plate 12A, the bipolar plate 12A is hard to decompose, deteriorate, or corrode. Further, even when the electrolytic solution contacts the main body portion 11A, the main body portion 11A is hard to decompose, deteriorate, or corrode.

Fiber contained in the thermoplastic resin can be, for example, a non-conductive fiber such as glass fiber or aramid fiber. The fiber may be short fiber or long fiber.

The fiber reinforced thermoplastic resin is a material having a high mechanical strength such as a tensile strength or a bend elastic constant as compared with resin that does not contain fiber.

In an embodiment, the inner frame 12 and the outer frame 11 are made of fiberglass-reinforced ABS resin.

In an example, the content of the glass fiber is set to a range of 10% to 30% by mass, inclusive. Note that the state where the content of the glass fiber is 10% by mass indicates a state where 10% of the mass of the whole fiberglass-reinforced ABS resin is glass fiber.

Fiberglass-reinforced ABS resin using chipped strands having an average diameter of 10 μm and an average length of 3 mm as the glass fiber is compared with ABS resin as follows.

That is, the ratio of the specific strength of the fiberglass-reinforced ABS resin to that of the ABS resin varies depending on the content of the glass fiber. The ratio is 1.50 when the content of the glass fiber is 10%, the ratio is 1.89 when the content is 20%, and the ratio is 2.02 when the content is 30%.

Further, the ratio of the elastic modulus of the fiberglass-reinforced ABS resin to that of the ABS resin varies depending on the content of the glass fiber. The ratio is 1.65 when the content of the glass fiber is 10%, the ratio is 2.57 when the content is 20%, and the ratio is 3.52 when the content is 30%.

As can be seen from this comparison, it is found that, when the content of the glass fiber is set to be between 10% by mass and 30% by mass, inclusive, the mechanical strengths of the inner frame 12 and the outer frame 11 improves.

### Adhesive Layer

It is preferable that the adhesive to be used for the adhesive layer 30 and adhesive layer 31 has sulfuric-acid resistance. The adhesive can be an epoxy-based adhesive, for example. An epoxy-based adhesive contains epoxy resin as a base compound, and an acid or basic hardening agent can be used as a hardening agent. The epoxy resin contained in the base compound may be, for example, bisphenol A epoxy resin or bisphenol F epoxy resin, but the epoxy resin is not limited to this.

### Electrolytic Layer 20

The electrolytic layer 20 is constituted by a glass-fiber mat impregnated with an electrolytic solution containing sulfuric acid, for example.

### Operations and Manufacture

At the time of manufacturing the bipolar lead storage battery 1, the adhesive is applied to the surface of the main body portion 11A of the outer frame 11, a corresponding positive lead layer 101 or negative lead layer 102 is attached and fixed thereto, for example, and then, a positive active material layer 103 or negative active material layer 104 corresponding to the positive lead layer 101 or negative lead layer 102 is attached thereto. Further, the adhesive is applied to both surfaces of the bipolar plate 12A of the inner frame 12, the positive lead layer 101 and the negative lead layer 102 are attached and fixed thereto, and the positive active material layer 103 and the negative active material layer 104 are attached to the positive lead layer 101 and the negative lead layer 102, so that the bipolar electrode 130 is manufactured.

In a state where the glass-fiber mat to form the electrolytic layer 20 is sandwiched between the negative electrode 110 and the positive electrode 120, a distal end part of the rise portion 11B of the outer frame 11 thus manufactured is brought into contact with a distal end part of the frame member 12B of the inner frame 12, and the rise portion 11B and the frame member 12B are joined to each other by vibration welding with a pressure being applied in the thickness direction. Further, in a state where the glass-fiber mat to form the electrolytic layer 20 is sandwiched between the negative electrode 110 and positive electrode 120, respective distal end parts of the frame members 12B of two inner frames 12 thus manufactured are brought into contact with each other, and the two frame members 12B are joined to each other by vibration welding with a pressure being applied thereto. This process is repeated for several layers to laminate a plurality of cell members via respective bipolar plates 12A, so that the outer frames 11 and the inner frames 12 (a framework) are assembled sequentially.

At the time of such a manufacture, repulsion in the thickness direction is applied between two bipolar plates 12A or between a bipolar plate 12A and the main body portion 11A due to the compression of the glass-fiber mat, and a load is always applied to a joined portion formed by vibration welding.

Further, due to the repulsion, the bipolar plate 12A made of resin or the main body portion 11A may deform in the thickness direction. In this assembling step, the framework by the outer frames 11 and the inner frames 12 has not been completed yet, and the rigidity is low. Therefore, at the time when the bipolar electrodes 130 are laminated, the outer frame 11 or the inner frame 12 may deform, or in a case where the outer frame 11 or the inner frame 12 has a low strength, the outer frame 11 or the inner frame 12 may break.

Further, because the outer frame 11 is placed at an end portion in the lamination direction to restrain deformation of the whole framework, a necessary strength is requested to the outer frame 11. However, when the outer frame 11 is thickened to improve its strength, a sink mark or distortion easily occurs at the time of injection molding.

Further, at the time when the bipolar lead storage battery 1 is used, a pressure caused by oxygen gas generated by the decomposition of water in the glass-fiber mat (the electrolytic layer 20) is also applied in addition to the repulsion due to the compression of the glass-fiber mat. Therefore, there is a concern that the outer frame 11 or the inner frame 12 receiving the repulsion may deform. This deformation is a problem related to the long-term reliability of the bipolar lead storage battery 1.

To deal with those problems, in the present embodiment, the mechanical strength of the outer frame 11 or the inner frame 12 is raised by using fiber reinforced thermoplastic resin for the outer frame 11 or the inner frame 12.

Accordingly, at the time of joining joined portions of a frame and a plate in a state where the repulsion by the glass-fiber mat is applied, it is possible to restrain the outer frame 11 or the inner frame 12 from deforming in the thickness direction and to improve the strengths of the joined portions (welding portions).

Further, because of restraint at the time of joining, the outer frame 11 or the inner frame 12 is restrained from deforming in the thickness direction at the time when the bipolar lead storage battery is used, so that the outer frame 11 or the inner frame 12 is restrained from breaking. As a result, the long-term reliability of the bipolar lead storage battery 1 improves.

For example, when the outer frame 11 or the inner frame 12 is made of fiberglass-reinforced ABS resin, the specific strength of the outer frame 11 or the inner frame 12 improves and can be reduced in weight, and the fixation of the positive lead layer 101 or negative lead layer 102 to the bipolar plate 12A with the adhesive is enabled. When the positive lead layer 101 or negative lead layer 102 is fixed to the bipolar plate 12A, the corrosion resistance of the positive lead layer 101 or negative lead layer 102 improves. Further, because the deformation of the outer frame 11 or the inner frame 12 is restrained, movement of the positive lead layer 101 or negative lead layer 102 is further restrained.

Further, particularly, a necessary strength is required by the outer frame 11 because the outer frame 11 is placed at an end portion in the lamination direction to restrain deformation of the whole framework. However, when the outer frame 11 is thickened to improve its strength, a sink mark or distortion easily occurs at the time of injection molding. In this regard, in the present embodiment, because the mechanical strength of the outer frame 11 is raised, the specific strength is raised, so that a necessary strength can be achieved even when the outer frame 11 is thin. Accordingly, the outer frame 11 can be relatively thinned so that its moldability improves. This leads to improvement of the evenness (molding accuracy) of the outer frame 11.

Further, by applying glass-fiber reinforced resin to the outer frame 11 or the inner frame 12, the deformation of the outer frame 11 or the inner frame 12 can be restrained even when the outer frame 11 or the inner frame 12 is thin, and this leads to reduction in the weight of the bipolar lead storage battery 1.

The above description deals with a case where the joined portions are joined by welding, but the joined portions may be joined by other well-known means such as an adhesive.

### Other Variations

This disclosure can also take the following configurations.

(1) A bipolar storage battery includes a plurality of cell members laminated on one another, the plurality of cell members each including a positive electrode and a negative electrode placed to face each other via an electrolytic layer. The bipolar storage battery includes inner frames, each including a bipolar plate provided between adjacent cell members, and a frame member (a rim) integrally connected to an outer peripheral portion of the bipolar plate and rising in a thickness direction of the bipolar plate. The bipolar storage battery also includes a pair of outer frames respectively placed at opposite end portions in a lamination direction of the plurality of cell members laminated on one another. The outer frames each include a main body portion (an end plate) having a plate shape, and a rise portion (a rim) integrally connected to an outer peripheral portion of the main body portion and rising toward the frame member. A chamber is formed between adjacent inner frames when respective frame members of the adjacent inner frames are joined to each other, and a chamber formed between an inner frame and an outer frame adjacent to the inner frame when the frame member of the inner frame is joined to the rise portion of the outer frame serve as cells in each of which a corresponding cell member is stored. At least either the inner frames or the outer frames are made of fiber reinforced thermoplastic resin.

In this configuration, because the fiber reinforced thermoplastic resin is used for at least one type of frames out of the inner frames and the outer frames, the mechanical strength of the at least one type of frames out of the inner frames and the outer frames is raised. As a result, it is possible to restrain the at least one type of frames out of the inner frames and the outer frames from deforming due to the pressure inside the cells and to thin the at least one type of frames out of the inner frames and the outer frames. As a result, it is possible to provide a bipolar storage battery that can balance long-term reliability with high energy density.

(2) The outer frames are made of fiber reinforced thermoplastic resin.

In this configuration, because the fiber reinforced thermoplastic resin is used for the outer frames, the mechanical strength of the outer frames is also raised. As a result, it is possible to restrain the outer frames from deforming due to the pressure inside the cells and to thin the outer frames.

Further, the moldability of the outer frames improves by thinning the outer frames. As a result, it is possible to provide a bipolar storage battery that can balance a longer-term reliability with high energy density.

(3) The fiber reinforced thermoplastic resin is fiberglass-reinforced ABS resin.

With this configuration, it is possible to improve the mechanical strength of at least the inner frames out of the inner frames and the outer frames.

(4) Another embodiment provides a bipolar storage battery including a plurality of cell members laminated on one another, the plurality of cell members each including a positive electrode and a negative electrode placed to face each other via an electrolytic layer. The bipolar storage battery includes inner frames, each including a bipolar plate provided between adjacent cell members, and a frame member (a rim) integrally connected to an outer peripheral portion of the bipolar plate and rising in a thickness direction of the bipolar plate. The bipolar storage battery also includes a pair of outer frames respectively placed at opposite end portions in a lamination direction of the plurality of cell members laminated on one another. The outer frames each include a main body portion (an end plate) having a plate shape, and a rise portion (a rim) integrally connected to an outer peripheral portion of the main body portion and rising toward the frame member. A chamber is formed between adjacent inner frames when respective frame members of the adjacent inner frames are joined to each other, and a chamber formed between an inner frame and an outer frame adjacent to the inner frame when the frame member of the inner frame is joined to the rise portion of the outer frame serve as cells in each of which a corresponding cell member is stored. The outer frames are made of fiber reinforced thermoplastic resin.

In this configuration, because the fiber reinforced thermoplastic resin is used for the outer frames, the mechanical strength of the outer frames is raised. As a result, it is possible to restrain the outer frames from deforming due to the pressure inside the cells and to thin the outer frames. As a result, it is possible to provide the bipolar lead storage battery 1 that can balance long-term reliability with high energy density.

Further, the outer frame is a frame placed at an end portion in the lamination direction, and therefore, it is necessary to form the outer frame with a thick thickness. In contrast, in the present embodiment, it is possible to make the outer frames thinner than before. In a case where the outer frames are thinned, it is possible to provide outer frames molded with accuracy such that a sink mark or distortion at the time of injection molding is restrained.

(5) The fiberglass-reinforced ABS resin has composition that the content of glass fiber is equal to or more than 10% by mass but equal to or less than 30% by mass (i.e., between 10% by mass and 30% by mass, inclusive).

With this configuration, it is possible to improve the mechanical strength of at least the inner frames out of the inner frames and the outer frames.

(6) The positive electrode and the negative electrode each include a lead layer and an active material layer disposed on the lead layer, and the lead layer is fixed to the bipolar plate with an adhesive. In this configuration, because the lead layer is fixed to the bipolar plate or the like, the corrosion resistance of the lead layer improves.

Particularly, in the present embodiment, because the deformation of the inner frames is restrained at the time of manufacture and at the time of use, the movement of the lead layer is restrained more, so that the corrosion resistance of the lead layer improves.

(7) Each of the positive electrode and the negative electrode includes a lead layer and an active material layer disposed on the lead layer, and the lead layer is fixed to the main body portion with an adhesive.

In this configuration, because the lead layer is fixed to the main body portion or the like, the corrosion resistance of the lead layer improves.

Particularly, in the present embodiment, because the deformation of the outer frames is restrained at the time of manufacture and at the time of use, the movement of the lead layer is restrained more, so that the corrosion resistance of the lead layer improves.

Here, Japanese Patent Application No. 2020-195488 (filed on Nov. 25, 2020) and Japanese Patent Application No. 2020-195489 (filed on Nov. 25, 2020) to which the present application claims priority is incorporated herein by reference in its entirety. Herein, the present invention has been described referring to a limited number of embodiments, but the scope of the present invention is not limited to them, and it is obvious for a person skilled in the art that the embodiments are modifiable based on the disclosure.

The following is a list of reference signs used in this specification and in the drawings.
1 bipolar lead storage battery
11 outer frame
11A main body portion (end plate)
11B rise portion (rim)
12 inner frame
12A bipolar plate
12B frame member (rim)
20 electrolytic layer
30 adhesive layer
31 adhesive layer
101 positive lead layer
102 negative lead layer
103 positive active material layer
104 negative active material layer
110 negative electrode
120 positive electrode
130 bipolar electrode

What is claimed is:

1. A bipolar storage battery, comprising:
a plurality of cell members laminated on one another, each of the plurality of cell members including a positive electrode and a negative electrode placed to face each other via an electrolytic layer;
inner frames, each inner frame including a bipolar plate provided between adjacent cell members, and a rim integrally connected to an outer peripheral portion of the bipolar plate and rising in a thickness direction of the bipolar plate; and
a pair of outer frames respectively placed at opposite end portions in a lamination direction of the plurality of cell members laminated on one another, wherein:
at least either the inner frames or the outer frames are made of fiber reinforced thermoplastic resin.

2. The bipolar storage battery according to claim 1, wherein:
each of the outer frames includes an end plate having a plate shape, and a rise portion integrally connected to an outer peripheral portion of the end plate and rising toward the rim; and
the outer frames are made of fiber reinforced thermoplastic resin.

3. The bipolar storage battery according to claim 2, wherein:
the fiber reinforced thermoplastic resin is fiberglass-reinforced ABS resin.

4. The bipolar storage battery according to claim 2, wherein:
each of the positive electrode and the negative electrode includes a lead layer and an active material layer disposed on the lead layer; and
the lead layer is fixed to the bipolar plate with an adhesive.

5. The bipolar storage battery according to claim 2, wherein:
each of the outer frames includes an end plate having a plate shape, and a rise portion integrally connected to an outer peripheral portion of the end plate and rising toward the rim;
each of the positive electrode and the negative electrode includes a lead layer and an active material layer disposed on the lead layer; and
the lead layer is fixed to the end plate with an adhesive.

6. The bipolar storage battery according to claim 1, wherein:
the fiber reinforced thermoplastic resin is fiberglass-reinforced ABS resin.

7. The bipolar storage battery according to claim 6, wherein:
each of the positive electrode and the negative electrode includes a lead layer and an active material layer disposed on the lead layer; and
the lead layer is fixed to the bipolar plate with an adhesive.

8. The bipolar storage battery according to claim 6, wherein:
each of the outer frames includes an end plate having a plate shape, and a rise portion integrally connected to an outer peripheral portion of the end plate and rising toward the rim;
each of the positive electrode and the negative electrode includes a lead layer and an active material layer disposed on the lead layer; and
the lead layer is fixed to the end plate with an adhesive.

9. The bipolar storage battery according to claim 6, wherein:
the fiberglass-reinforced ABS resin has a composition that a content of glass fiber is equal to or more than 10% by mass and equal to or less than 30% by mass.

10. The bipolar storage battery according to claim 9, wherein:
each of the positive electrode and the negative electrode includes a lead layer and an active material layer disposed on the lead layer; and
the lead layer is fixed to the bipolar plate with an adhesive.

11. The bipolar storage battery according to claim 9, wherein:
each of the outer frames includes an end plate having a plate shape, and a rise portion integrally connected to an outer peripheral portion of the end plate and rising toward the rim;
each of the positive electrode and the negative electrode includes a lead layer and an active material layer disposed on the lead layer; and
the lead layer is fixed to the end plate with an adhesive.

12. The bipolar storage battery according to claim 1, wherein:
each of the positive electrode and the negative electrode includes a lead layer and an active material layer disposed on the lead layer; and
the lead layer is fixed to the bipolar plate with an adhesive.

13. The bipolar storage battery according to claim 12, wherein:
each of the outer frames includes an end plate having a plate shape, and a rise portion integrally connected to an outer peripheral portion of the end plate and rising toward the rim;
each of the positive electrode and the negative electrode includes a lead layer and an active material layer disposed on the lead layer; and
the lead layer is fixed to the end plate with an adhesive.

14. The bipolar storage battery according to claim 1, wherein:
each of the outer frames includes an end plate having a plate shape, and a rise portion integrally connected to an outer peripheral portion of the end plate and rising toward the rim;
each of the positive electrode and the negative electrode includes a lead layer and an active material layer disposed on the lead layer; and
the lead layer is fixed to the end plate with an adhesive.
